(19) United States
(12) Patent Application Publication
(10) Pub. No.: US 2019/0196708 A1
(43) Pub. Date: Jun. 27, 2019

(54) CAMERA-DETECTED TOUCH INPUT

(71) Applicant: Astro HQ LLC, Minnetonka, MN (US)

(72) Inventors: Giovanni Donelli, San Francisco, CA (US); Thomas Court, Minnetonka, MN (US); Matt Ronge, Minnetonka, MN (US)

(21) Appl. No.: 15/853,373

(22) Filed: Dec. 22, 2017

(51) Int. Cl. G06F 3/0488; H04N 5/232; G06F 3/041

(52) U.S. Cl. CPC G06F 3/04883; G06F 3/0485; G06F 3/0412; H04N 5/23216

(57) ABSTRACT

Disclosed in some examples are computing devices, methods, systems, and machine readable mediums that detect touch events on a camera lens of a digital video camera of a computing device. The computing devices monitor the images produced by the digital video camera and detect when a user has placed their finger (and in some examples, another object) onto the camera lens. This action is registered as a touch event. The detected touch events may be simple events, such as a press event (e.g., the user puts their finger on the lens where the camera lens is treated as a “virtual” button), or more advanced events, such as gestures. Example gestures include scrolling, pinching, zooming, and the like.

### TECHNICAL

Embodiments pertain to user input devices. Some embodiments relate to detecting touch inputs using a digital video camera of a mobile device.

### BACKGROUND

Computing devices are being equipped with an ever increasing number of sensors. For example, front and/or rear facing cameras, motion sensors, Global Positioning Sensors (GPS), rotation sensors, light sensors, and the like. These computing devices also have touch sensitive displays for providing input in lieu of a traditional keyboard and mouse.

### BRIEF DESCRIPTION OF THE DRAWINGS

in the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-3 show a step-by-step illustration of a button press event and a subsequent selection from a menu shown in response to the detected button press event according to some examples of the present disclosure.

FIG. 4 shows a diagram of a swipe gesture event and subsequent scrolling of content according to some examples of the present disclosure.

FIG. 5 shows a flowchart of a method of detecting a touch event using a digital video digital video camera according to some examples of the present disclosure.

FIG. 6 shows a state transition diagram of scanning for touch events according to some examples of the present disclosure.

FIG. 7 shows a flowchart of a method for scanning frames captured by the digital video camera to determine a touch event according to some examples of the present disclosure.

FIG. 8 shows an example of a source image with sampled points as squares according to some examples of the present disclosure.

FIG. 9 shows an example of brightness and smoothness plotted over time of a finger-down touch event according to some examples of the present disclosure.

FIG. 10 shows a plot of expected red coloration in an image as a function of brightness according to some examples of the present disclosure.

FIG. 11 shows a logical block diagram of a computing device with camera-detected touch input according to some examples of the present disclosure.

FIG. 12 is a block diagram illustrating an example of a machine upon which one or more embodiments may be implemented.

### DETAILED DESCRIPTION

Software applications running on computing devices with a touchscreen usually need to draw buttons on the screen to let the user perform actions. Buttons on a touch screen generally occlude content underneath, or at least limit available space. For example, in a drawing application, a button on a touchscreen might hide the canvas. For computing devices with smaller screens such a phone this may mean a significant percentage of the screen is devoted to just displaying buttons as opposed to showing relevant content. A button drawn on the screen also forces to the user to lay her/his hand on the display to press it, additionally reducing visibility of the screen by the user and smudging the screen with fingerprints. Additionally, a button on touch screen may not be as fast in recording a touch event as a camera. Generally touch screens take on average 100 milliseconds (ms) to record the event of a finger touching the screen.

Disclosed in some examples are computing devices, methods, systems, and machine readable mediums that detect touch events on a camera lens of a digital video camera of a computing device. The computing device monitors the images produced by the digital video camera and detects when a user has placed their finger (and in some examples, another object) onto the camera lens. This action is registered as a touch event. The detected touch events may be simple events, such as a press event (e.g., the user puts their finger on the lens where the camera lens is treated as a “virtual” button), or more advanced events; such as gestures. Example gestures include scrolling, pinching, zooming, and the like. Advantages of using a camera for a touch event over using a touch screen may include the ability to enter input that does not block the display screen, a lower latency input device (a camera running at 30 frames per second can respond to input in less than 20 ms on average), increased durability (a digital video camera behind a lens is less liable to break than a touch screen); and the like.

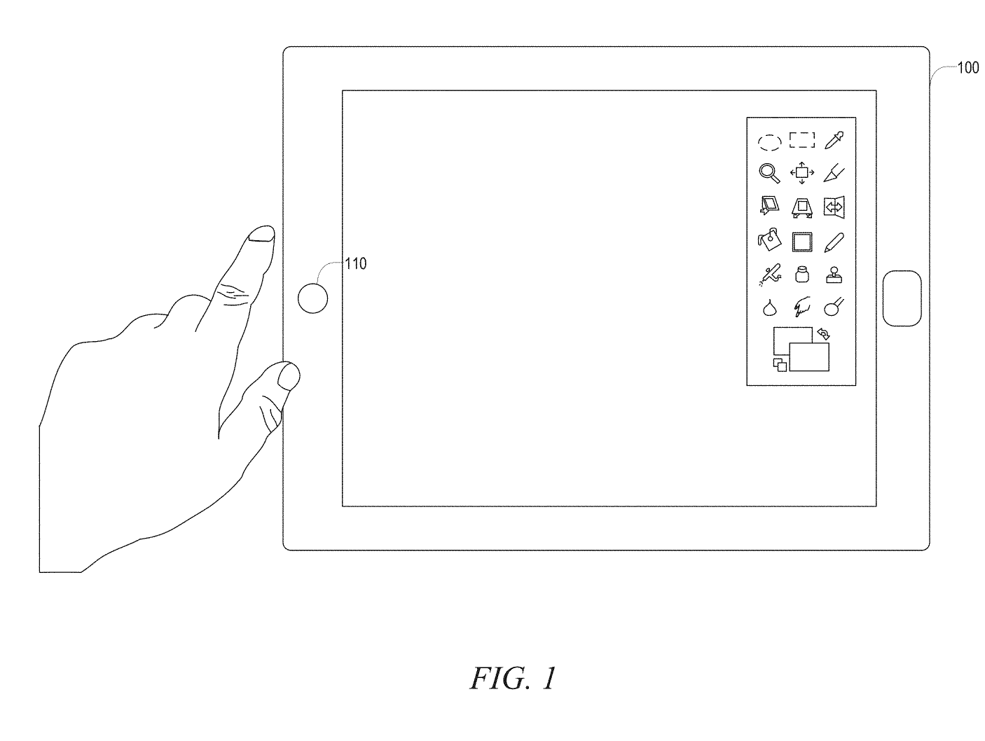

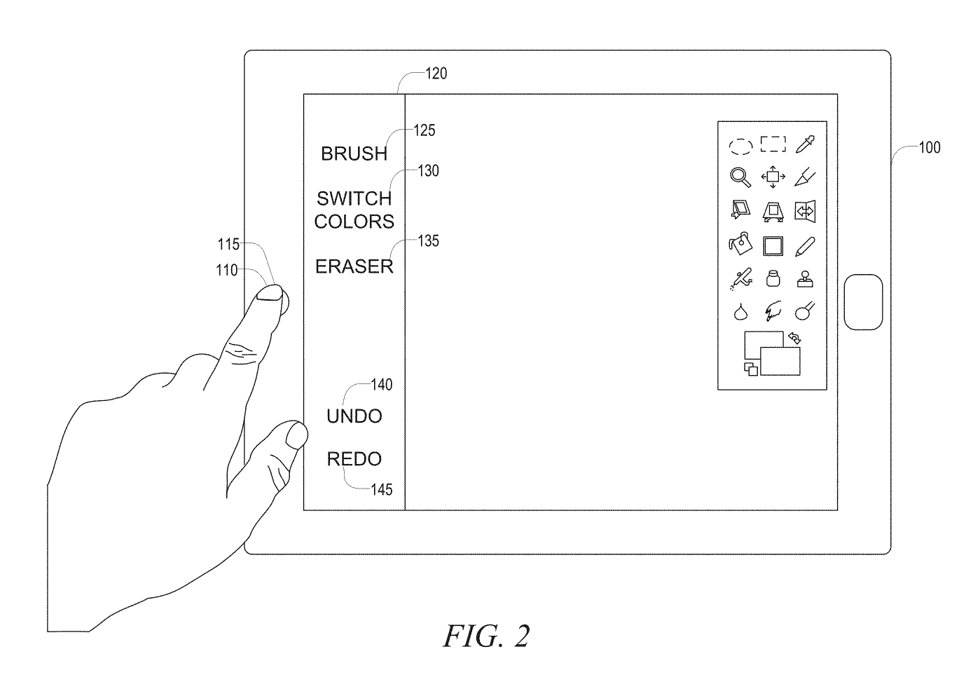

Turning now to FIGS. 1-3 a step-by-step illustration of a button press event is shown according to some examples of the present disclosure. FIG. 1 shows a computing device 100 of a user—in this case a tablet computing device. The computing device 100 is running a drawing application in these examples, but one of ordinary skill with the benefit of the present disclosure will appreciate that any application that utilizes user input may be configured to accept the touch events generated from monitoring the digital video camera according to the present disclosure. The computing device 100 includes a user-facing digital video camera 110. In FIG. 1, the lens of the digital video camera is unobstructed by the user's finger 115. FIG. 2 shows the user pressing their finger 115 on the camera lens of the user-facing digital video camera 110 to register a touch event with the computing device 100. An application executing on the computing device (either the drawing application, a background application, the operating system, or the like) may detect the user's finger on the camera lens using an analysis of video frames from the digital video camera 110. The input of the user's finger on the digital video camera lens triggers a touch event, such as a virtual “button.” This touch event is utilized as user input by applications executing (either the same application that detected the user's finger on the digital video camera lens or a different application) on the computing device 100. For example; the touch event may cause a menu to be displayed, such as menu 120. Other touch events may include selection of already displayed Graphical User Interface (GUI) elements, scrolling (horizontally or vertically), pinching, zooming, flinging, or the like.

In some examples, the computing device may distinguish between different touch events based upon the user's interaction with the digital video camera 110. For example, if the user covers the digital video camera lens, a first touch event (a press touch event) may be registered. If the user swipes their finger over the digital video camera lens of the digital video camera, a swipe event may be generated, and so on. Thus, multiple different touch events may be generated depending on the motion of the user's finger(s). Each touch event may have an associated reaction on the part of the application—e.g., a swipe event may scroll a list of items or a page of content; a button press event may cause a menu to be displayed or a menu option to be selected; and the like.

In the example of FIG. 2, a menu 120 is displayed on the touch screen display of the computing device with user selectable options, such as an option to change a brush used in the drawing program 125, an option to switch colors 130, an option to change a current drawing tool to an eraser tool 135, an option to undo a last operation 140, and an operation to redo a previously undone operation 145. In an example an item from the menu 120 may be selected while avoiding touching the touchscreen display. For example, the user may press the digital video camera 110 twice, once to open the menu 120 and a second time to select a menu item (e.g., by first scrolling to a selection using the digital video camera 110 as described below). Not touching the touchscreen display may allow the user to not smudge the touchscreen display or interfere with a view of the touchscreen display (e.g., when menu 120 is transparent or partially transparent).

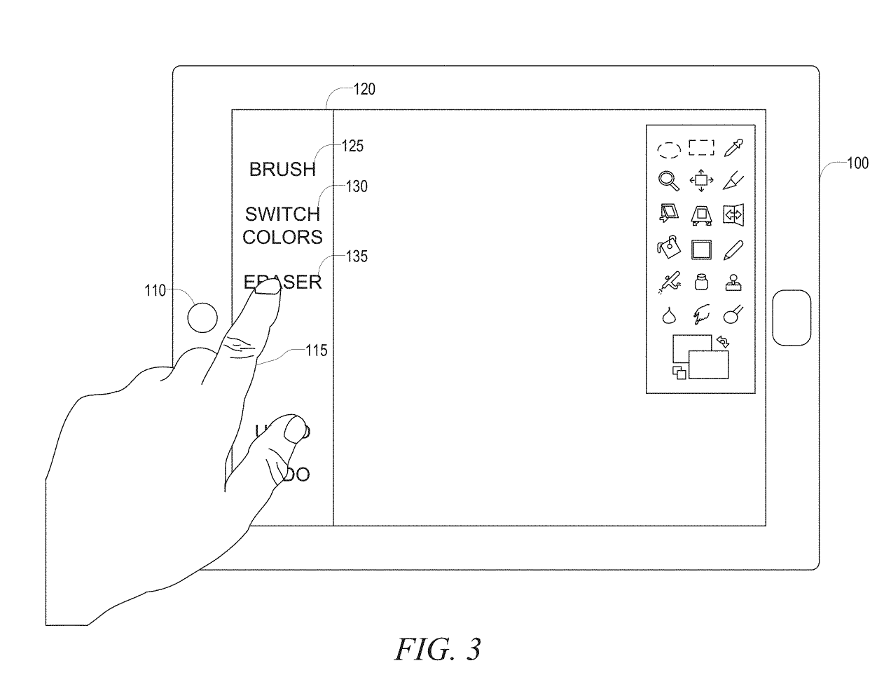

As shown in FIG. 3, the user may move their finger off the lens of the digital video camera 110 to select one of these options. In these examples, the menu 120 stays displayed until a user selects an option, or applies an input to either to touchscreen display that is at a location away from the menu 120 or applies another input to the digital video camera 110. In other examples, the menu 120 is only displayed for as long as the user's finger 115 remains on the digital video camera lens of digital video camera 110. In these examples, the user may use a first finger to cover the digital video camera lens of digital video camera 110 to activate the menu 120 and second finger to select one of the options of the menu. In still other examples, the user may utilize the digital video camera to make a selection off the menu 120—for example, once the menu is displayed (e.g., after the button press event is detected), the user may scroll a selection bar across the options of the menu 120 by swiping across the lens of the digital video camera 110 with their finger 115 and may select one of the options by tapping the lens of the digital video camera 110.

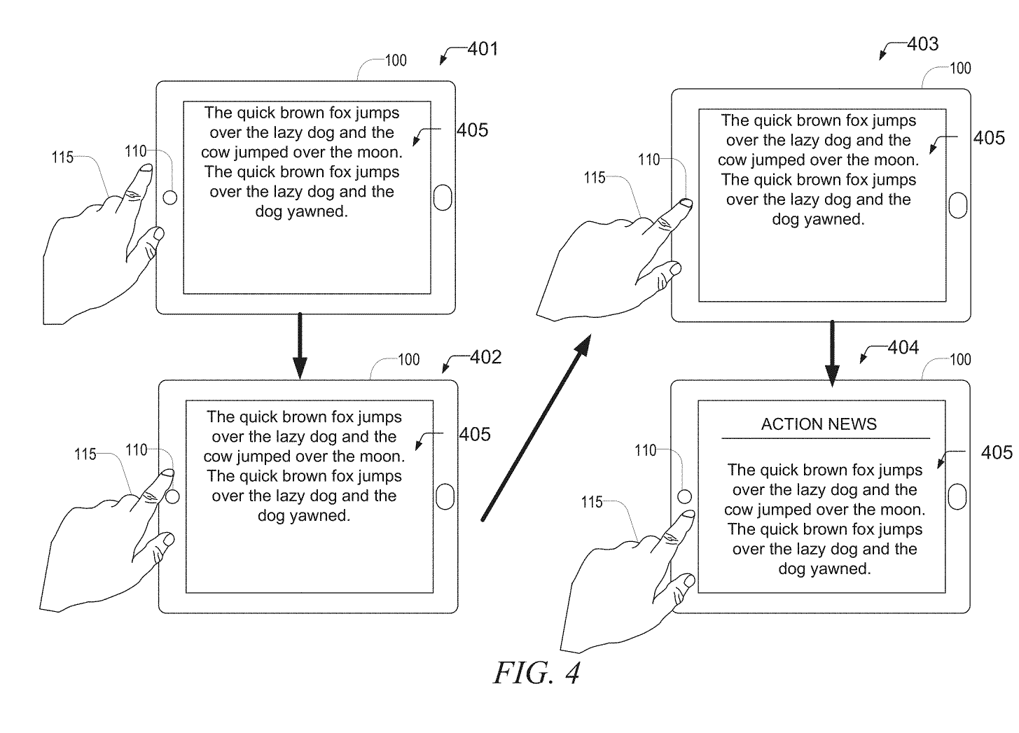

FIG. 4 shows a diagram of a swipe gesture event and subsequent scrolling of content according to some examples of the present disclosure. Finger 115 swipes from above the digital video camera 110 to below the digital video camera 110 in succession (from 401 to 402, to 403, and finally 404). This causes content 405 to scroll downward. Other scrolling gestures may be utilized such as horizontal and vertical scrolling, pinch, zoom, and the like. Scrolling by swiping the digital video camera 110 may include not touching the touchscreen display of the computing device 100.

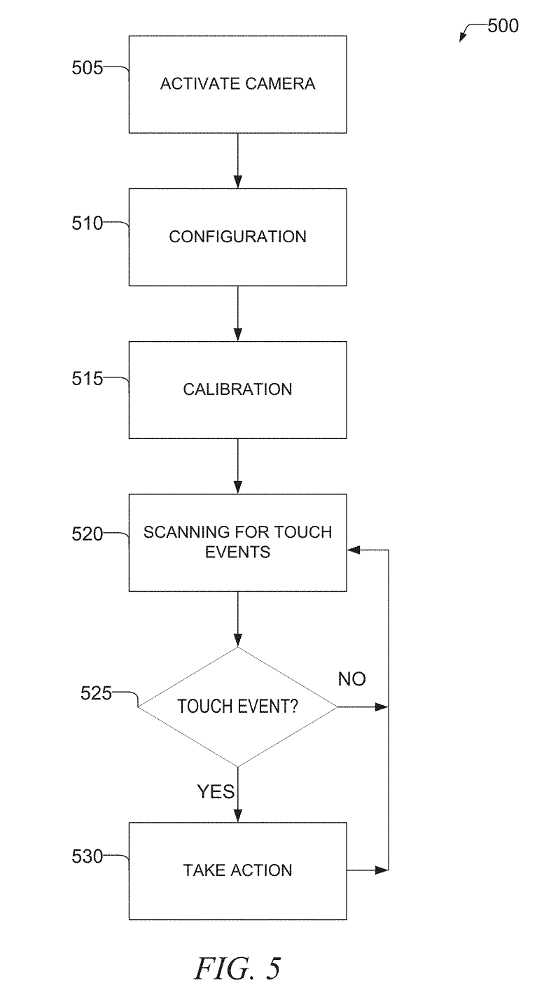

Turning now to FIG. 5, a flowchart of a method 500 of detecting a touch event using a digital video digital video camera is shown according to some examples of the present disclosure. At operation 505 the digital video camera may be activated, and at operation 510 the digital video camera may be configured. For example, the rate at which the digital video camera captures images (e.g., frames-per-second), the image quality (e.g., the number of pixels captured), and the like may be configured. In some examples, the digital video camera may be configured to provide the lowest quality output (e.g., lowest resolution and/or lowest capture rate) to save resources (e.g., battery, computational resources, and the like) of the computing device. If the digital video camera supports a low-light mode, that also may be activated.

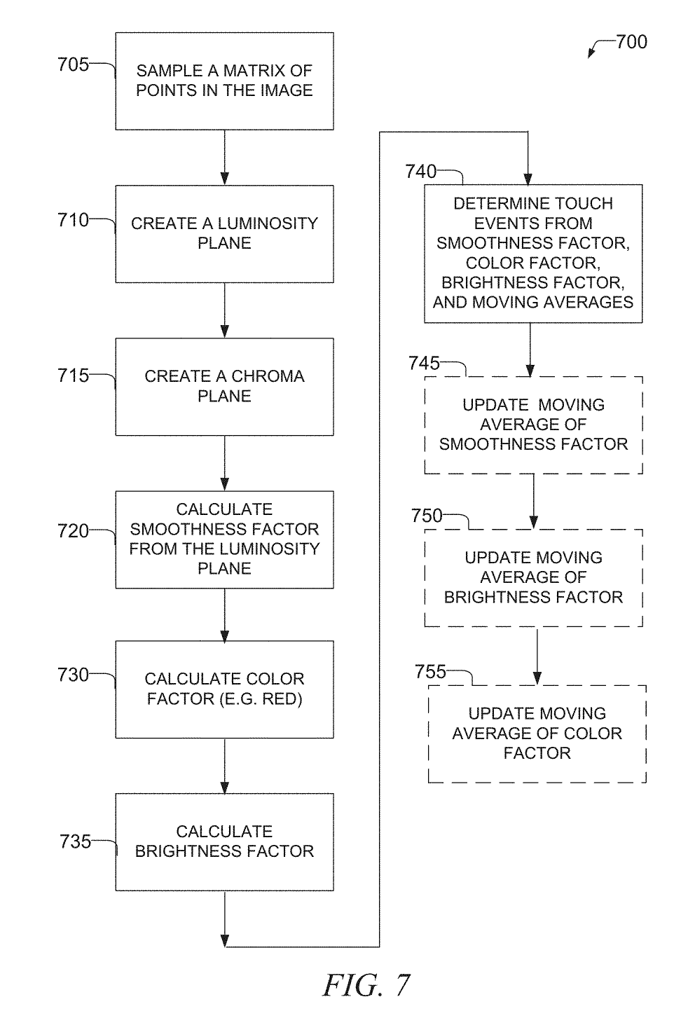

At operation 515 the digital video camera may be calibrated. In some examples, baseline moving averages for smoothness factor, brightness factor, and color factor may be calculated for a predetermined period of time. These factors are explained in more detail later in the specification. That is, a predetermined amount of data (e.g., 1 second's worth) may be utilized to calculate the moving average that is used in later steps (e.g., see FIG. 7). This may provide the application detecting the touch gestures with a baseline model for what an image captured from the digital video camera looks like in the present environment of the computing device. For example, depending on the lighting conditions, a touch may look different from room to room. This calibration may be done at application start up, and may be done periodically to capture changes in the environment of the user.

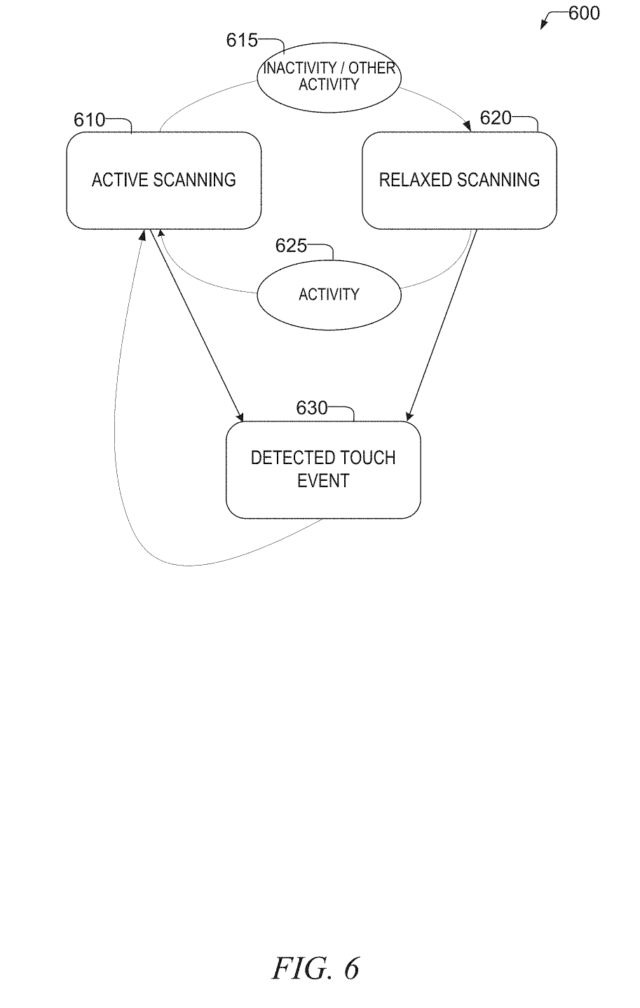

At operation 520 the application may scan for touch events by analyzing video frames received from the digital video camera to determine if a touch event has been detected. The application may check frames at a certain rate (e.g., at a certain frames-per-second) that may be predetermined. In some examples, in order to conserve battery, the fps may be less than a maximum fps that can be captured by the digital video camera. In some examples, the application may adjust the rate at which frames are scanned in response to activity by the user, or a lack of activity by the user. The frame rate may be adjusted by changing the frame capture rate of the digital video camera, or by only processing certain frames (e.g., only processing every nth frame). For example, if the user is not actively engaging with the computing device (e.g., entering inputs) for a predetermined period of time, the application may throttle back the capture rate of the digital video camera, and/or the amount of frames checked by the application for a touch event. More details on this dynamic checking is shown in FIG. 6. Operation 520 may also detect the type of touch event (e.g., a press, a swipe, a pinch, a zoom).

At operation 525, if a touch event was detected at operation 520, then one or more applications may be notified and may take action at operation 530. For example, the application that detects the touch event may cause an action to be performed responsive to detecting the touch event (e.g., display a menu, scroll content, select an option, and the like), may send a notification to another application that has registered to receive such events, and the like. After the action has been taken, the system may return to operation 520 and continue scanning for touch events. In some examples, applications interested in receiving touch events of the camera may register to receive the events and provide callback functions to execute on detection of these events. Upon detecting the event, the computing device may execute these callback functions. For example, a driver or services of an operating system may register the callbacks, detect the events, and send notifications to registered callbacks upon detecting the events. If no event is detected, the system may return to operation 520 and continue scanning for touch events.

Turning now to FIG. 6 a state transition diagram 600 of scanning for touch events (e.g., operation 520 of FIG. 5) is shown according to some examples of the present disclosure. Scanning may start in either the active scanning state 610 or the relaxed scanning state 620. The active scanning state 610 scans for touch events on the digital video camera lens at an increased rate over the relaxed scanning state 620. For example, the active scanning state 610 may set the device's digital video camera to capture at a high frame rate (e.g., 24 fps). Each frame (or a subset of the captured frames) may be analyzed to determine if the frame indicates a touch event. In the relaxed scanning state 620, the device's digital video camera may capture video at a reduced frame rate relative to the active scanning state 610, for example 10 frames per second (fps). The relaxed scanning state 620 is a state that is less demanding in device resources (battery use, computation power) as compared to the active scanning state 610. The active scanning state 610 is used if the system expects a touch event. The system may expect touch events if previous touch events have occurred recently. The relaxed scanning state 620 is entered after a period of inactivity of the user or through detection of certain activities that indicate a touch event is not likely to be detected. This is indicated by transition 615. An example of activities that indicate a touch event is not likely to be detected include activities with the touch screen, such as active drawing in a drawing application of the user. Likewise, when the user stops those activities (e.g., stops interacting with the touch screen), or becomes active (e.g., by utilizing the camera button), the system re-enters active scanning state 610 through transition 625. In either active scanning state 610 or relaxed scanning state 620, a touch event may be detected and transition the system to the detected touch event state 630 where the event is processed and applications are notified of the event. As previously noted, once a touch event is detected with the digital video camera, the system transitions back to the active state 610.

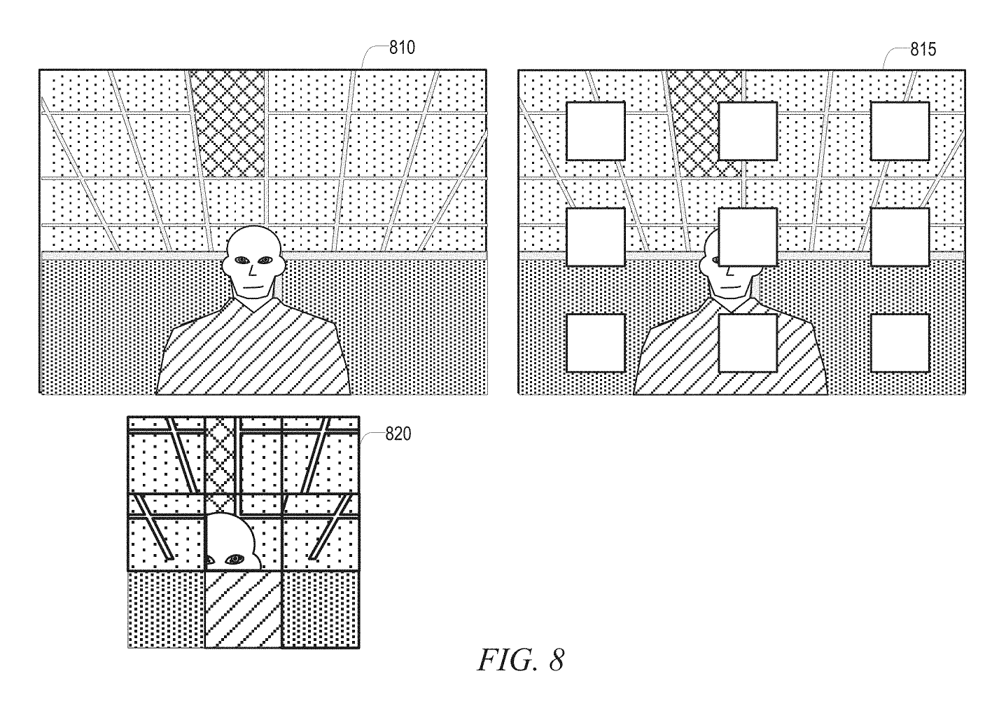

As noted, in each state, the active scanning state 610, and the relaxed scanning state 620, the system scans frames captured by the digital video camera for touch events. Turning now to FIG. 7 a flowchart of a method 700 for scanning frames captured by the digital video camera to determine a touch event is shown according to some examples of the present disclosure. As noted, this method is performed in either the active or relaxed states. The operations of FIG. 7 may be performed for all video frames (e.g., images) captured by the digital video camera or for a subset of all the video frames captured. At operation 705, the system may sample a matrix of points in the image. For example, if the original camera image size is a resolution of 2000×1600 pixels, the image may be reduced by sampling every other 100 pixels to obtain an image of 20×16 pixels. In some examples, the edges of the image may not be used as sample points as they may be noisy and the sensor may be less reliable. FIG. 8 shows an example of a source image 810 with sampled points as squares in image 815. The resulting downsampled image 820 is then used in subsequent operations. At operation 710, a LumaPlane or luminosity plane may be calculated from the downsampled image that stores the brightness value of each pixel in the downsampled image. At operation 715, a ChromaPlane may be calculated from the downsampled image that stores the color information of each pixel in the downsampled image.

At operation 720 a smoothness factor may be calculated for the current video frame from the LumaPlane. The smoothness factor is a measure of how homogenous the source image is. A finger on the digital video camera creates an image whose pixel values are very similar that is, a smoothness factor close to zero. When the digital video camera is unobstructed it is likely that the environment in the image captured by the digital video camera is noisy. This results in a smoothness factor that is much greater than zero. In some examples, smoothness factor may be calculated as:

```
int smoothnessSum=0;
for (int y=0; y<kVisionResolutionHeight−1;y++) // row
{
      for (int x=0; x<kVisionResolutionWidth−1; x++)
      {
            int luma = LumaPlane[x,y];
            // how different is the current pixel from the one to the right
            int diff = luma−LumaPlane[x+1,y];
            smoothnessSum += diff*diff;
            // how different is the current pixel from the one below
            int diff = luma − LumaPlane[x,y+1];
            smoothnessSum += diff*diff;
      }
}
float smoothnessfactor = (float)smoothnessSum/
      ((kVisionResolutionWidth−1)*(kVisionResolutionHeight−1)*2);
```

In the above formula, kVisionResolutionWidth is the width in pixels of the down sampled image and kVisionResolutionHeight is the height in pixels of the downsampled image.

At operation 730, a color factor (e.g., red) may be calculated for the current video frame from the ChromaPlane. When a finger is placed on the camera, the resulting image may not be black, but may have a particular color profile. This is due to the autofocus and auto-exposure adjustments in digital video cameras of many portable electronics devices. These devices adjust the exposure levels to compensate for low lighting (e.g., when a finger is covering the lens) by increasing the ISO. This makes these digital video cameras very sensitive to low light. Environmental light filters through the human body and is captured by the digital video camera. This light may have a particular color profile. For example, this light may be a red color (which may be due to the blood in the finger or other biological properties).

The color factor may be, for example, a red factor that may be calculated as:

float redFactor=sum of all red pixel values of the image/number of pixels;

At operation 735, a brightness factor may be calculated from EXIF data of the video frame. The digital video camera has meta data associated with its settings such as the ISO used, the exposure, the lens type, and the like. This metadata is stored in a data format called EXIF. One of the values in the EXIF information is brightness. Modern digital video cameras try to adjust to variable lighting conditions like the human eye does. The brightness factor may include the quantity of light coming in the lens. When a finger is placed on the digital video camera, the brightness factor is lower.

At operation 740, the system may determine whether there is a touch event indicated by the current frame based upon a comparison between the smoothness factor, color factor, and brightness factor of the current frame and the calculated moving averages of these values. For example, as noted previously, the moving average is calibrated at operation 515 of FIG. 5 and then updated periodically (e.g., on a frame-by-frame basis). If the current frame's current value for smoothness factor, brightness factor and/or color factor is different from the moving average by a threshold amount, it may indicate a touch event. The threshold amount may be a predetermined threshold value. The use of the moving averages as a basis for the comparison allows the system to continuously calibrate itself to the current environmental conditions. This allows for the expected use of portable computing devices (e.g., tablets, smartphones, laptops, and the like) being moved during usage.

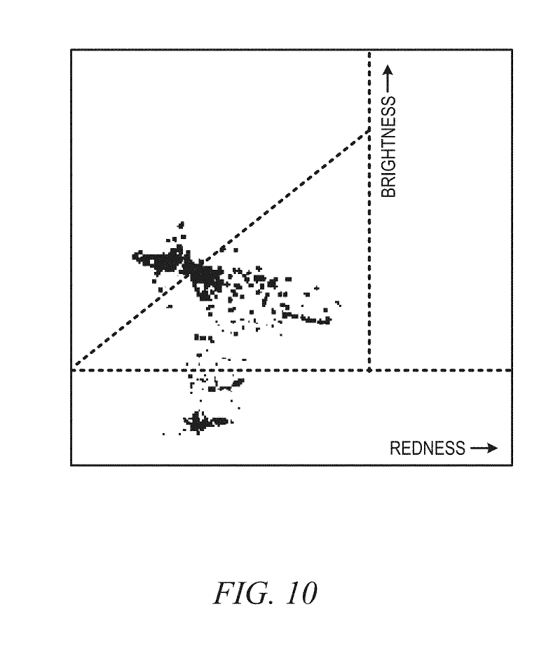

In one example, each of the brightness factor, smoothness factor, and color factor (e.g., red factor) may be utilized in determining whether a touch event has occurred. In other examples, one or more of those factors may not be utilized. In some examples, the color factor may be correlated with the brightness factor. For example, the more light there is, the more vibrant red will be present. In a dark environment, the image may be expected to have less red. For example, FIG. 10 shows an example graph of brightness value to expected redness value. The dotted lines identify an area of space where the button is engaged. In some examples, where the brightness is very low, the red factor may be ignored.

In one example, the following may determine whether a touch event has occurred:

```
BOOL fingerDown =
      (brightness < avgBrightness - brightness_variance_threshold)
            &&
      (smoothness < averageSmoothness - smoothness variance
      threshold)
            &&
      (
            (red > MinRednessForAlwaysRed)
                  ||
            (brightness < kMinBrightnessForRednessCheck)
                  ||
            (red > (brightness-kMinBrightnessForRednessCheck)/
            kBrightnessToRednessSlope)
);
```

where:
brightness is the brightness factor calculated for the current frame, avgBrightness may be the moving average of the brightness factor, and brightness_variance_threshold may be the expected variance of the brightness from the average. This may be a predetermined value.
Smoothness is the smoothness factor of the current frame, averageSmoothness may be the moving average of the smoothness factor, and smoothness_variance_threshold may be the expected variance of the smoothness from the average.
Red may be the color factor (in this example, red), MinRednessForAlwaysRed is a level of red in the image that indicates the image is mostly red, kMinBrightnessForRednessCheck is a minimum brightness where the red component of the image becomes useful (e.g., if the brightness is less than this threshold, then the amount of red in the image is negligible or uninformative.) This value may be predetermined. kBrightnesstoRednessSlope may be the slope of the diagonal dotted line in FIG. 10.

At operation 745, operation 750, and operation 755 the moving averages of the smoothness factor, brightness factor, and color factor may be updated. These steps are shown in dotted lines to highlight that in some examples, if a touch event is detected, the moving averages are not updated with the new brightness, smoothness and color values until the touch event has ended (e.g., the brightness, smoothness, and color values return to within threshold values of the respective moving average before the touch event). Not updating the moving averages may be done to avoid contaminating the normal average values for the particular environment with values observed during a touch event.

The moving average of the smoothness factor may be updated using the formula:

New Smoothness Factor Moving Average=Old Smoothness Factor Moving Average*weight+(smoothness factor calculated at operation 720*(1/weight))

Where the weight is a factor used to determine whether to weight the present value (alpha close to 0) or the previous values (alpha close to 1) more in determining the new average.

At operation 750, the moving average of the brightness factor may similarly be updated (with a same or different alpha value as the smoothness factor). For example, using the formula:

New Brightness Factor Moving Average=Old Brightness Factor Moving Average*weight+(brightness factor calculated at operation 735*(1/weight))

Where the weight is a factor used to determine whether to weight the present value (alpha close to 0) or the previous values (alpha close to 1) more in determining the new average. The weight used to calculate the brightness factor moving average may be the same weight or a different weight as used to calculate the smoothness factor moving average.

In some examples, a moving average is not used in the color value (as shown in the pseudo code above), but in other examples, a moving average may be utilized. In examples in which a moving average of the color factor may be utilized, then at operation 755, the moving average of the color factor may be similarly updated (with a same or different alpha value as the smoothness factor and/or brightness factor). For example, using the formula:

New Color Factor Moving Average=Old Color Factor Moving Average*weight+(color calculated at operation 730*(1/weight))

Where the weight is a factor used to determine whether to weight the present value (alpha close to 0) or the previous values (alpha close to 1) more in determining the new average. The weight used to calculate the color factor moving average may be the same weight or a different weight as used to calculate the brightness and/or smoothness factor moving averages.

In some examples, to detect gestures, the system may divide the image captured by the digital video camera into regions. Various gestures may be detected based upon the regions that register a touch input. For example, if the bottom regions register a finger press first, and then the top regions, this may indicate a scroll down gesture. Similarly, if the top regions register the finger press first, and then the bottom regions, this may indicate a scroll up gesture.

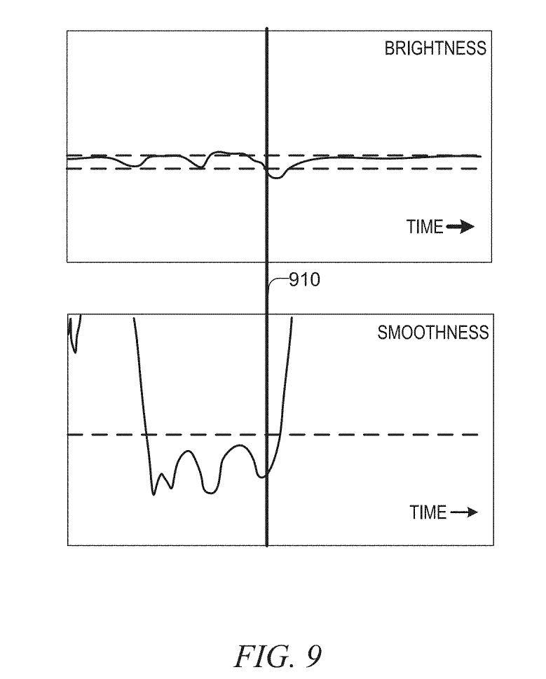

FIG. 9 shows an example of brightness and smoothness plotted over time of a finger-down touch event. For example, the horizontal lines indicate a normal environment average minimum and maximum brightness values—e.g., the variability between the dotted line is considered within the norm of the current environment. The line represents the digital video camera brightness over time. At the touch down event, shown by line 910, the brightness drops below the accepted normal range. Similarly, the smoothness graph below the brightness graph shows smoothness over time—the line represents the finger press event. In the Example of FIG. 9, the smoothness factor was engaged prior to the finger down touch event as the experimenter was hovering their finger close to the surface without putting their finger down. The color factor's (e.g., red factor's) role in the decision making depends on the brightness of the image. The lighter the image, the more vibrant red will be present in the image, and the opposite is also true in a dark environment there will be less red that will shine through a user's finger. FIG. 10 shows a plot of expected red coloration in the image as a function of brightness. The dotted lines identify an area of the space where the button is considered engaged.

As previously described gestures may be detected. These may be detected by subdividing the area of coverage of the camera lens into sections and looking for button press events on each area of coverage over several frames to detect motion. For example, a button press event on a top section that spreads to bottom sections and then a return to normal (e.g., the system detects that a finger is no longer present) on the top sections suggests a swipe motion from top to bottom. Similar detections may be employed for horizontal swipes, pinches, spreads, and other gestures.

While a single camera-based gesture detection has been discussed to this point, in other examples, the system may detect user input corresponding to the multiple digital video cameras. For example a front and a rear facing digital video camera may be used to detect user input—such as the user placing a finger over the digital video camera. The second video camera may add another button for detecting touch events. Additionally, complex gestures can be formed from the user's interaction with the front and rear facing digital video cameras simultaneously or in sequence. For example a flipping gesture may be created if the user swipes a finger across the user facing digital video camera in a first direction and swipes a second finger on an opposite facing digital video camera in a second direction (opposite of the first direction). The flipping gesture may be used to rotate an object, horizontally, vertically, diagonally, or some combination thereof.

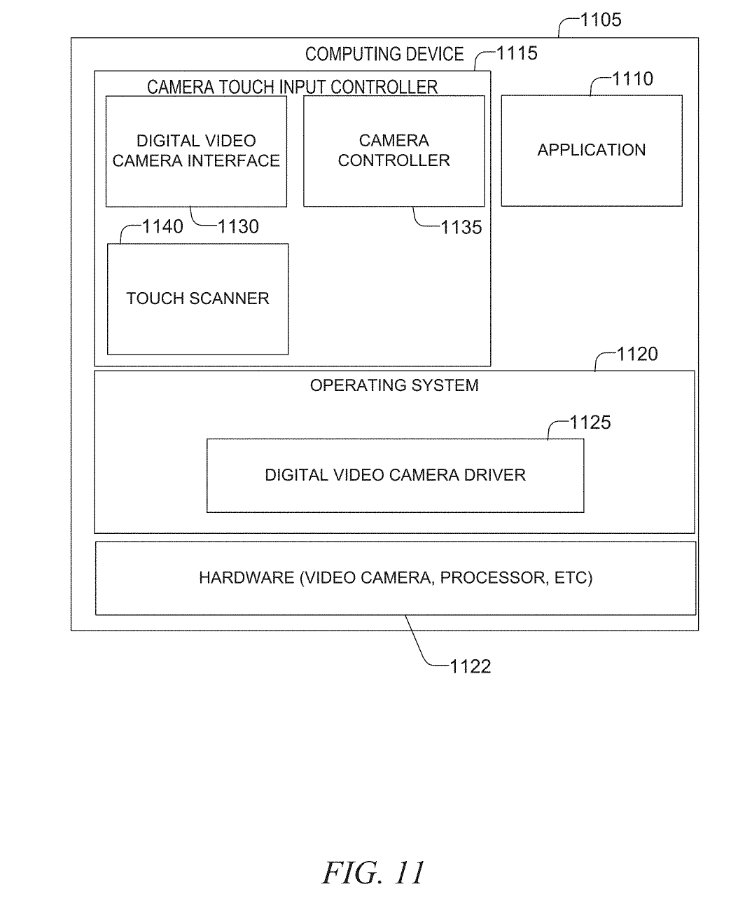

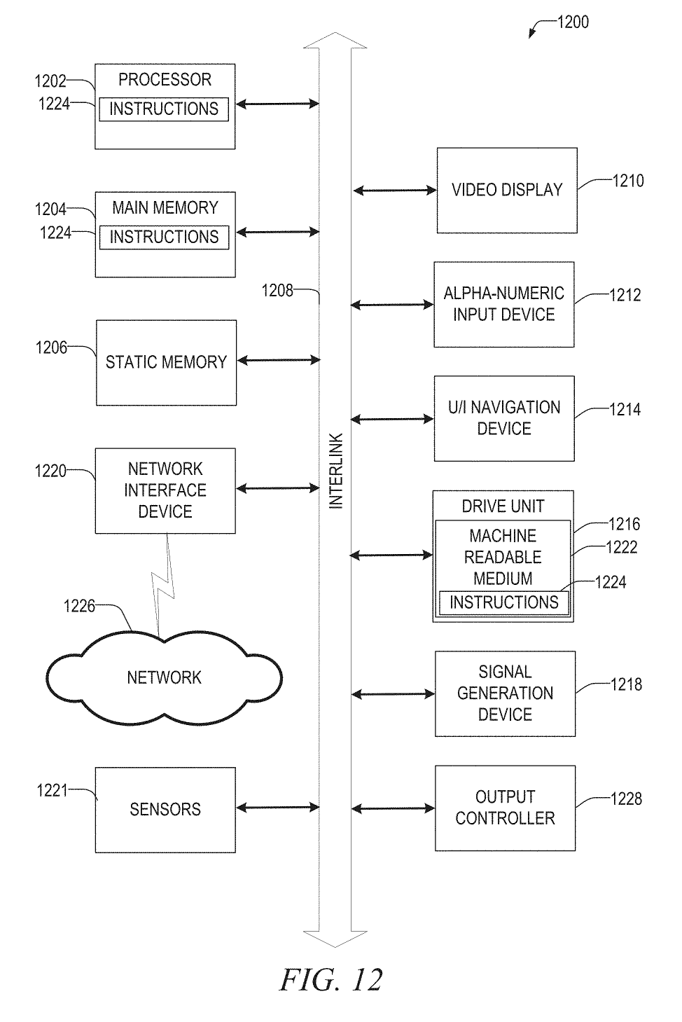

Turning now to FIG. 11, a logical block diagram of a computing device 1105 with camera-detected touch input is shown according to some examples of the present disclosure. Hardware 1122 includes a digital video camera, a processor, volatile memory (Random Access Memory), storage, and the like. Example hardware may include a digital video camera, which may include a complementary metal-oxide-semiconductor (CMOS) sensor, a charge-coupled device (CCD) sensor, and the like. Other example hardware includes components from FIG. 12 (e.g., a processor, memory, storage, sensors, networking devices, and the like). Operating system 1120 provides various services to applications executing on the computing device 1105, such as programmatic access to the hardware 1122, process scheduling, interrupt services, graphical user interface (GUI) services, display services, and the like. For example, the operating system 1120 may include digital video camera driver 1125 that controls the digital video camera and provides an interface within the operating system 1120 for applications to turn on and off the digital video camera, set a frame rate, set various settings of the digital video camera, receive images from the digital video camera, and the like. Application 1110 may utilize these services of the operating system 1120 to provide an application to a user of the computing device 1105. Example applications include a drawing application, a graphic design application, a photo-editing application, a web-browsing application, a picture viewing application, a productivity application (e.g., word processing application, email application, slide presentation application), and the like. For example, application 1110 may be any application capable of accepting a touch input.

Camera touch input controller 1115 may be a separate application, an operating service, or may be integrated with application 1110. Camera touch input controller 1115 may have a digital video camera interface 1130 that may communicate with the digital video camera driver 1125 (e.g., through operating system 1120). Camera controller 1135 may implement the method diagram of FIG. 5 with the assistance of the digital video camera interface 1130 and the touch scanner 1140. For example, the camera controller 1135 may activate the digital video camera, configure the digital video camera, calibrate the digital video camera, and set the digital video camera in the correct scanning mode, depending on whether the camera touch input controller 1115 is in the active scanning or relaxed scanning state. Camera controller 1135 may implement the state transition diagram of FIG. 6 and may track and receive user input or activity indicators to transition at the appropriate times to the appropriate states.

Frames received from the digital video camera through the digital video camera interface 1130 may be processed by the touch scanner 1140 to determine if a touch event is recognized. For example, the touch scanner may implement the operations of FIG. 7, such as calculating the matrix, creating the luminosity and chroma planes, calculating the smoothness factor, color factor, and determining the brightness factor. The touch scanner 1140 may also retrieve and/or calculate moving averages for these values, compare the moving averages to expected values, and the like to determine whether a touch event has occurred. Touch scanner 1140 may also determine which type of touch event (e.g., finger down, swipe, pinch, zoom, etc. . . . ) has occurred and send an indication to other applications (e.g., through operating system 1120 or directly through process-to-process communication to applications, such as application 1110. In other examples, if camera touch input controller 1115 is part of the application, then the touch scanner 1140 may call another module to take action on the touch input that was detected.

FIG. 12 illustrates a block diagram of an example machine 1200 upon which any one or more of the techniques (e.g., methodologies) discussed herein may perform. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine may be a computing device such as computing device 100, may implement the method of FIG. 5, the state transitions of FIG. 6, the method of FIG. 7, and be configured as in FIG. 11. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). For example, the components of FIG. 11. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink (e.g., bus) 1208. The machine 1200 may further include a display unit 1210, an alphanumeric input device 1212 (e.g., a keyboard), and a user interface (UI) navigation device 1214 (e.g., a mouse). In an example, the display unit 1210, input device 1212 and UI navigation device 1214 may be a touch screen display. The machine 1200 may additionally include a storage device (e.g., drive unit) 1216, a signal generation device 1218 (e.g., a speaker), a network interface device 1220, and one or more sensors 1221, such as a global positioning system (GPS) sensor, compass, accelerometer, light sensor (such as a digital video camera) or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206, or the storage device 1216 may constitute machine readable media.

While the machine readable medium 1222 is illustrated as a single medium, the term “machine readable medium” may include a single medium or multiple media (e.g., a centralized or distributed database, and/or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1224 may further be transmitted or received over a communications network 1226 using a transmission medium via the network interface device 1220. The Machine 1200 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. In some examples, the network interface device 1220 may wirelessly, communicate using Multiple User IMMO techniques.

### Other Notes and Examples

Example 1 is a computing device, comprising: a processor; a digital video camera communicatively connected to the processor; a memory, storing instructions, which when performed by the processor, cause the processor to perform operations comprising: determining that a lens of the digital video camera was at least partially touched by a human finger; and responsive to determining that the lens of the digital video camera was touched by the human finger, recognizing a touch event in an application running on the processor.

In Example 2, the subject matter of Example 1 includes, wherein the operations further comprise; responsive to recognizing the touch event in the application running on the processor, causing a menu to be displayed.

In Example 3, the subject matter of Examples 1-2 includes, wherein the operations further comprise: determining that a user has swiped their finger across the lens of the digital video camera by comparing two different video frames captured at two different times and determining that an area of the lens that is touched changes directionally, and wherein the operations of recognizing the touch event comprise recognizing the touch event as a swipe gesture.

In Example 4, the subject matter of Example 3 includes, wherein the area of the lens that is touched changes directionally in a horizontal direction, and wherein the operations of recognizing the touch event comprise recognizing the touch event as a horizontal swipe gesture.

In Example 5, the subject matter of Examples 3-4 includes, wherein the area of the lens that is touched changes directionally in a vertical direction, and wherein the operations of recognizing the touch event comprise recognizing the touch event as a vertical swipe gesture.

In Example 6, the subject matter of Examples 1-5 includes, wherein the operations of determining that the lens of the digital video camera was at least partially touched by the human finger comprise: determining a base parameter of a first image generated by the digital video camera; receiving a second image generated by the digital video camera, the second image generated at a later time than the first image; and determining that the lens of the digital video camera was at least partially touched by the human finger based upon a comparison of the base parameter with a same parameter of the second image.

In Example 7, the subject matter of Example 6 includes, wherein the base parameter is a color uniformity.

In Example 8, the subject matter of Examples 6-7 includes, wherein the base parameter is an amount of red color.

In Example 9, the subject matter of Examples 6-8 includes, wherein the base parameter is a brightness.

In Example 10, the subject matter of Examples 1-9 includes, wherein the operations of determining that the lens of the digital video camera was at least partially touched by the human finger comprises: determining a color uniformity base parameter of a first image generated by the digital video camera; determining a color component base parameter of the first image; determining a brightness base parameter of the first image; receiving a second image generated by the digital video camera, the second image generated at a later time than the first image; determining that the lens of the digital video camera was at least partially touched by the human finger based upon: a comparison of the color uniformity base parameter with a color uniformity of the second image; a comparison of the brightness base parameter with a brightness of the second image; and a comparison of the color component base parameter with a color component of the second image.

Example 11 is a non-transitory machine-readable medium, comprising instructions, which when performed by a machine, causes the machine to perform operations of: determining that a lens of a digital video camera was at least partially touched by a human finger; and responsive to determining that the lens of the digital video camera was touched by the human finger, recognizing a touch event in an application.

In Example 12, the subject matter of Example 11 includes, wherein the operations further comprise, responsive to recognizing the touch event in the application, causing a menu to be displayed on a display.

In Example 13, the subject matter of Examples 11-12 includes, wherein the operations further comprise: determining that a user has swiped their finger across the lens of the digital video camera by comparing two different video frames captured at two different times and determining that an area of the lens that is touched changes directionally, and wherein the operations of recognizing the touch event comprise recognizing the touch event as a swipe gesture.

In Example 14, the subject matter of Example 13 includes, wherein the area of the lens that is touched changes directionally in a horizontal direction, and wherein the operations of recognizing the touch event comprise recognizing the touch event as a horizontal swipe gesture.

In Example 15, the subject flatter of Examples 13-14 includes, wherein the area of the lens that is touched changes directionally in a vertical direction, and wherein the operations of recognizing the touch event comprise recognizing the touch event as a vertical swipe gesture.

In Example 16, the subject matter of Examples 11-15 includes, wherein the operations of determining that the lens of the digital video camera was at least partially touched by the human finger comprise: determining a base parameter of a first image generated by the digital video camera; receiving a second image generated by the digital video camera, the second image generated at a later time than the first image; and determining that the lens of the digital video camera was at least partially touched by the human finger based upon a comparison of the base parameter with a same parameter of the second image.

In Example 17, the subject matter of Example 16 includes, wherein the base parameter is a color uniformity.

In Example 18, the subject matter of Examples 16-17 includes, wherein the base parameter is an amount of red color.

In Example 19, the subject matter of Examples 16-18 includes, wherein the base parameter is a brightness.

In Example 20, the subject matter of Examples 11-19 includes, wherein the operations of determining that the lens of the digital video camera was at least partially touched by the human finger comprises: determining a color uniformity base parameter of a first image generated by the digital video camera; determining a color component base parameter of the first image; determining a brightness base parameter of the first image; receiving a second image generated by the digital video camera, the second image generated at a later time than the first image; determining that the lens of the digital video camera was at least partially touched by the human finger based upon: a comparison of the color uniformity base parameter with a color uniformity of the second image; a comparison of the brightness base parameter with a brightness of the second image; and a comparison of the color component base parameter with a color component of the second image.

Example 21 is a method, performed by a processor of a computing device, the method comprising: determining that a lens of a digital video camera was at least partially touched by a human finger; and responsive to determining that the lens of the digital video camera was touched by the human finger, recognizing a touch event in an application.

In Example 22, the subject flatter of Example 21 includes, wherein the method further comprises: responsive to recognizing the touch event in the application, causing a menu to be displayed on a display.

In Example 23, the subject matter of Examples 21-22 includes; wherein the method further comprises: determining that a user has swiped their finger across the lens of the digital video camera by comparing two different video frames captured at two different times and determining that an area of the lens that is touched changes directionally, and wherein recognizing the touch event comprise recognizing the touch event as a swipe gesture.

In Example 24, the subject matter of Example 23 includes, wherein the area of the lens that is touched changes directionally in a horizontal direction, and wherein recognizing the touch event comprises recognizing the touch event as a horizontal swipe gesture.

In Example 25, the subject matter of Examples 23-24 includes, wherein the area of the lens that is touched changes directionally in a vertical direction, and wherein recognizing the touch event comprises recognizing the touch event as a vertical swipe gesture.

In Example 26, the subject matter of Examples 21-5 includes, wherein determining that the lens of the digital video camera was at least partially touched by the human finger comprises: determining a base parameter of a first image generated by the digital video camera; receiving a second image generated by the digital video camera, the second image generated at a later time than the first image; and determining that the lens of the digital video camera was at least partially touched by the human finger based upon a comparison of the base parameter with a same parameter of the second image.

In Example 27, the subject matter of Example 26 includes, wherein the base parameter is a color uniformity.

In Example 28, the subject matter of Examples 26-27 includes, wherein the base parameter is an amount of red color.

In Example 29, the subject matter of Examples 26-28 includes, wherein the base parameter is a brightness.

In Example 30, the subject matter of Examples 21-29 includes, wherein determining that the lens of the digital video camera was at least partially touched by the human finger comprises: determining a color uniformity base parameter of a first image generated by the digital video camera; determining a color component base parameter of the first image; determining a brightness base parameter of the first image; receiving a second image generated by the digital video camera, the second image generated at a later time than the first image; determining that the lens of the digital video camera was at least partially touched by the human finger based upon: a comparison of the color uniformity base parameter with a color uniformity of the second image; a comparison of the brightness base parameter with a brightness of the second image; and a comparison of the color component base parameter with a color component of the second image.

Example 31 is a computing device comprising: a digital video camera; means for determining that a lens of the digital video camera was at least partially touched by a human finger; and responsive to determining that the lens of the digital video camera was touched by the human finger, means for recognizing a touch event in an application.

In Example 32, the subject matter of Example 31 includes, wherein the device further comprises: means for causing a menu to be displayed on a display responsive to recognizing the touch event in the application.

In Example 33, the subject matter of Examples 31-32 includes, wherein the device further comprises: means for determining that a user has swiped their finger across the lens of the digital video camera by comparing two different video frames captured at two different times and determining that an area of the lens that is touched changes directionally, and wherein the means for recognizing the touch event comprise means for recognizing the touch event as a swipe gesture.

In Example 34, the subject matter of Example 33 includes, wherein the area of the lens that is touched changes directionally in a horizontal direction, and wherein the means for recognizing the touch event comprises means for recognizing the touch event as a horizontal swipe gesture.

In Example 35, the subject matter of Examples 33-34 includes, wherein the area of the lens that is touched changes directionally in a vertical direction, and wherein the means for recognizing the touch event comprises means for recognizing the touch event as a vertical swipe gesture.

In Example 36, the subject matter of Examples 31-35 includes; wherein the means for determining that the lens of the digital video camera was at least partially touched by the human finger comprises: means for determining a base parameter of a first image generated by the digital video camera; means for receiving a second image generated by the digital video camera, the second image generated at a later time than the first image; and means for determining that the lens of the digital video camera was at least partially touched by the human finger based upon a comparison of the base parameter with a same parameter of the second image.

In Example 37, the subject matter of Example 36 includes, wherein the base parameter is a color uniformity.

In Example 38, the subject matter of Examples 36-37 includes, wherein the base parameter is an amount of red color.

In Example 39, the subject matter of Examples 36-38 includes, wherein the base parameter is a brightness.

In Example 40, the subject matter of Examples 31-39 includes, wherein the means for determining that the lens of the digital video camera was at least partially touched by the human finger comprises: means for determining a color uniformity base parameter of a first image generated by the digital video camera; means for determining a color component base parameter of the first image; means for determining a brightness base parameter of the first image; means for receiving a second image generated by the digital video camera, the second image generated at a later time than the first image; means for determining that the lens of the digital video camera was at least partially touched by the human finger based upon: a comparison of the color uniformity base parameter with a color uniformity of the second image; a comparison of the brightness base parameter with a brightness of the second image; and a comparison of the color component base parameter with a color component of the second image.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

What is claimed is:

1. A computing device, comprising:
a processor;
a digital video camera communicatively connected to the processor;
a memory, storing instructions, which when performed by the processor, cause the processor to perform operations comprising:
determining that a lens of the digital video camera was at least partially touched by a human finger; and
responsive to determining that the lens of the digital video camera was touched by the human finger, recognizing a touch event in an application running on the processor.

2. The computing device of claim 1, wherein the operations further comprise, responsive to recognizing the touch event in the application running on the processor, causing a menu to be displayed.

3. The computing device of claim 1, wherein the operations further comprise:
determining that a user has swiped their finger across the lens of the digital video camera by comparing two different video frames captured at two different times and determining that an area of the lens that is touched changes directionally, and wherein the operations of recognizing the touch event comprise recognizing the touch event as a swipe gesture.

4. The computing device of claim 3, wherein the area of the lens that is touched changes directionally in a horizontal direction, and wherein the operations of recognizing the touch event comprise recognizing the touch event as a horizontal swipe gesture.

5. The computing device of claim 3, wherein the area of the lens that is touched changes directionally in a vertical direction, and wherein the operations of recognizing the touch event comprise recognizing the touch event as a vertical swipe gesture.

6. The computing device of claim 1, wherein the operations of determining that the lens of the digital video camera was at least partially touched by the human finger comprise:
determining a base parameter of a first image generated by the digital video camera;
receiving a second image generated by the digital video camera, the second image generated at a later time than the first image; and
determining that the lens of the digital video camera was at least partially touched by the human finger based upon a comparison of the base parameter with a same parameter of the second image.

7. The computing device of claim 6, wherein the base parameter is a color uniformity.

8. The computing device of claim 6, wherein the base parameter is an amount of red color.

9. The computing device of claim 6, wherein the base parameter is a brightness.

10. The computing device of claim 1, wherein the operations of determining that the lens of the digital video camera was at least partially touched by the human finger comprises:
determining a color uniformity base parameter of a first image generated by the digital video camera;
determining a color component base parameter of the first image;
determining a brightness base parameter of the first image;
receiving a second image generated by the digital video camera, the second image generated at a later time than the first image;
determining that the lens of the digital video camera was at least partially touched by human finger based upon:
a comparison of the color uniformity base parameter with a color uniformity of the second image;
a comparison of the brightness base parameter with a brightness of the second image; and
a comparison of the color component base parameter with a color component of the second image.

11. A non-transitory machine-readable medium, comprising instructions, which when performed by a machine, causes the machine to perform operations of:
determining that a lens of a digital video camera was at least partially touched by a human finger; and
responsive to determining that the lens of the digital video camera was touched by the human finger, recognizing a touch event in an application.

12. The machine-readable medium of claim 11, wherein the operations further comprise, responsive to recognizing the touch event in the application, causing a menu to be displayed on a display.

13. The machine-readable medium of claim 11, wherein the operations further comprise:
determining that a user has swiped their finger across the lens of the digital video camera by comparing two different video frames captured at two different times and determining that an area of the lens that is touched changes directionally, and wherein the operations of recognizing the touch event comprise recognizing the touch event as a swipe gesture.

14. The machine-readable medium of claim 13, wherein the area of the lens that is touched changes directionally in a horizontal direction, and wherein the operations of recognizing the touch event comprise recognizing the touch event as a horizontal swipe gesture.

15. The machine-readable medium of claim 13, wherein the area of the lens that is touched changes directionally in a vertical direction, and wherein the operations of recognizing the touch event comprise recognizing the touch event as a vertical swipe gesture.

16. The machine-readable medium of claim 11, wherein the operations of determining that the lens of the digital video camera was at least partially touched by the human finger comprise:
determining a base parameter of a first image generated by the digital video camera;
receiving a second image generated by the digital video camera, the second image generated at a later time than the first image; and
determining that the lens of the digital video camera was at least partially touched by the human finger based upon a comparison of the base parameter with a same parameter of the second image.

17. The machine-readable medium of claim 11, wherein the operations of determining that the lens of the digital video camera was at least partially touched by the human finger comprises:
determining a color uniformity base parameter of a first image generated by the digital video camera;
determining a color component base parameter of the first image;
determining a brightness base parameter of the first image;
receiving a second image generated by the digital video camera, the second image generated at a later time than the first image;
determining that the lens of the digital video camera was at least partially touched by human finger based upon:
a comparison of the color uniformity base parameter with a color uniformity of the second image;
a comparison of the brightness base parameter with a brightness of the second image; and
a comparison of the color component base parameter with a color component of the second image.

18. A method, performed by a processor of a computing device, the method comprising:
determining that a lens of a digital video camera was at least partially touched by a human finger; and
responsive to determining that the lens of the digital video camera was touched by the human finger, recognizing a touch event in an application.

19. The method of claim 18, wherein the method further comprises: responsive to recognizing the touch event in the application, causing a menu to be displayed on a display.

70. The method of claim 18, wherein the method further comprises:
determining that a user has swiped their finger across the lens of the digital video camera by comparing two different video frames captured at two different times and determining that an area of the lens that is touched changes directionally, and wherein recognizing the touch event comprise recognizing the touch event as a swipe gesture.
